(19) United States
(12) Patent Application Publication
(10) Pub. No.: US 2026/0266997 A1
(43) Pub. Date: Sep. 10, 2026

(54) VEHICLE LAMP

(71) Applicant: Stanley Electric Co., Ltd., Tokyo (JP)

(72) Inventors: Tadashi KAWATA, Tokyo (JP); Junpei INMARU, Tokyo (JP); Jun ANDO, Tokyo (JP)

(21) Appl. No.: 18/847,049

(22) PCT Filed: Mar. 9, 2023
(86) PCT No.: PCT/JP2023/008957

§ 371 Date: Sep. 13, 2024

(30) Foreign Application Priority Data
Mar. 14, 2022 (JP) 2022-039422

(51) Int. Cl. G01S 17/86; B60Q 1/00; F21S 41/147; F21S 41/19; F21S 41/36; F21S 41/39; F21S 45/47; G01S 7/481; G01S 7/497

(52) U.S. Cl. CPC G01S 17/86; B60Q 1/0023; F21S 41/147; F21S 41/192; F21S 41/36; F21S 41/39; F21S 45/47; G01S 7/4812; G01S 7/4817; G01S 7/497

(57) ABSTRACT

The vehicle lamp can include: a first light source that emits visible light; a first reflecting surface for the vehicle lamp that is designed to reflect the visible light emitted by the first light source to form a first light distribution pattern; a second light source that emits light for detecting a detection object transmitted to a first detection range; a light reception element that outputs an electric signal corresponding to intensity of a return light, when the return light that is the reflected light of the light reflected by the detection object is entered; a LiDAR apparatus that has the second light source and light reception element; a reflecting surface for the LiDAR apparatus that is designed to reflect the light for detecting the detection object and transmit it to a second detection range that is wider than the first detection range.

This application is a U.S. National Stage Application under 35 U.S.C § 371 of International Patent Application No. PCT/JP2023/008957 filed Mar. 9, 2023, which claims the benefit of priority under 35 U.S.C. § 119 to Japanese Patent Application No. 2022-039422 filed Mar. 14, 2022, the disclosures of all of which are hereby incorporated by reference in their entireties.

### TECHNICAL FIELD

The present disclosure relates to a vehicle lamp, and in particular to a vehicle lamp that does not require space for installing a reflector (reflecting surface) to reflect detection light (and its return light) for detecting a detection object (e.g., preceding vehicle, oncoming vehicle, pedestrian, bicycle, and motorcycle) transmitted from a LiDAR apparatus and is capable of being miniaturized.

### BACKGROUND ART

Patent Literature 1 discloses a vehicle lamp that includes a LiDAR apparatus provided so as to be invisible from outside of the vehicle, and a reflecting plate (reflecting surface) reflecting light (and its return light) for detecting a detection object (e.g., preceding vehicle, oncoming vehicle, pedestrian, bicycle, and motorcycle) transmitted from the LiDAR apparatus.

### CITATION LIST

### Patent Literature

Patent Literature 1: International Patent Publication No. WO 2019/203177

### SUMMARY OF INVENTION

### Technical Problem

However, in the vehicle lamp described in Patent Literature 1, there is a problem that a dedicated reflector (reflecting surface) to reflect detection light (and its return light) for detecting a detection object (e.g., preceding vehicle, oncoming vehicle, pedestrian, bicycle, and motorcycle) transmitted from a LiDAR apparatus must be installed, which increases the number of components and leads to higher costs. Additionally, there is also a problem that space must be secured for the installation of the dedicated reflector (reflecting surface), making it difficult to reduce the size of the vehicle lamp.

The present disclosure is made to solve such problems, and an object of the present disclosure is to provide a vehicle lamp that does not require a dedicated reflector (reflecting surface) to reflect light (and its return light) for detecting the detection object (e.g., preceding vehicle, oncoming vehicle, pedestrian, bicycle, and motorcycle) and its installation space, and is capable of being miniaturized.

### Solution to Problem

A vehicle lamp according to the present disclosure includes: a first reflecting surface for the vehicle lamp that is designed to reflect the visible light emitted by the first light source to form a first light distribution pattern; a second light source that emits light for detecting a detection object transmitted to a first detection range; a light reception element that outputs an electric signal corresponding to intensity of a return light, when the return light that is the reflected light of the light reflected by the detection object is entered; a LiDAR apparatus that has the second light source and light reception element; a reflecting surface for the LiDAR apparatus that is designed to reflect the light for detecting the detection object and transmit it to a second detection range that is wider than the first detection range; and a reflector formed with the first reflecting surface for the vehicle lamp and the reflecting surface for the LiDAR apparatus.

With such a configuration, it is possible to provide a vehicle lamp that does not require a dedicated reflector (reflecting surface) to reflect light transmitted from a LiDAR apparatus (and its return light) for detecting the detection object (e.g., preceding vehicle, oncoming vehicle, pedestrian, bicycle, and motorcycle) and its installation space, and is capable of being miniaturized.

This is due to the use of a reflector (one reflector) formed a reflecting surface for both a vehicle lamp and a reflecting surface for a LiDAR apparatus instead of installing a dedicated reflector (reflecting surface) to reflect light transmitted from a LiDAR apparatus (and its return light) for detecting the detection object, as described in the above-mentioned Patent Literature 1.

In the above-described vehicle lamp, the LiDAR apparatus may include a MEMS mirror for reflecting the light for detecting a detection object so that the light for detecting a detection object scans the first detection range.

In the above-described vehicle lamp, the first reflecting surface for the vehicle lamp and the reflecting surface for the LiDAR apparatus may be formed inside the outer shape of the reflector in front view.

In the above-described vehicle lamp, the outer shape of the reflector may be a circular shape in front view.

In the above-described vehicle lamp, the reflecting surface for the LiDAR apparatus may be designed such that the light for detecting a detection object reflected by the reflecting surface for the LiDAR apparatus is diffused in the horizontal direction.

In the above-described vehicle lamp, a vertical cross-sectional shape of the reflecting surface for the LiDAR apparatus may be a substantially parabolic shape, and a focal point thereof may be positioned near the MEMS mirror, and a radius of curvature of the lateral cross-sectional shape of the reflecting surface for the LiDAR apparatus may be greater than a radius of curvature of the vertical cross-sectional shape of the reflecting surface for the LiDAR apparatus.

In the above-described vehicle lamp, the reflecting surface for the LiDAR apparatus may include a plurality of reflecting regions formed by dividing the reflecting surface for the LiDAR apparatus, and each of the reflecting regions may be designed as a convex surface or a concave surface so as to diffuse the light for detecting the detection object emitted by the second light source and reflected by each of the reflecting regions in the horizontal direction.

In the above-described vehicle lamp, a through-hole is formed in the reflector; the vehicle lamp may include: a holding member for holding the first light source and the LiDAR apparatus, wherein the holding member is disposed in a state of being inserted into the through-hole.

In the above-described vehicle lamp may include a third light source that emits visible light; a second reflecting surface for the vehicle lamp that is designed to reflect the visible light emitted by the third light source to form a second light distribution pattern; wherein the holding member has a triangular prism shape, and the first light source, the LiDAR apparatus, and the third light source are each fixed to surfaces that constitute the sides of the triangular prism shape.

In the above-described vehicle lamp, the holding member may be a heat sink.

In the above-described vehicle lamp, the LiDAR apparatus may be disposed behind the reflector. the vehicle lamp may include: a reflecting member for reflecting light for detecting a detection object emitted from the second light source and passing through the through-hole toward the reflecting surface for the LiDAR apparatus.

In the above-described vehicle lamp, the reflecting member may be a mirror or a prism.

In the above-described vehicle lamp, the reflecting member may be a condensing reflecting surface, the light reflected by the condensing reflecting surface may crosse and be directed towards the reflecting surface for the LiDAR apparatus.

In the above-described vehicle lamp may include: a signal processing unit that calculates the distance to the detection object based on the electrical signal output by the light reception element and outputs the angle of the detection object and the distance to the detection object; a storage unit in that a correction data is stored; a correction unit that corrects the angle of the detection object outputted from the signal processing unit, based on the correction data.

### Advantageous Effects of Invention

According to the present disclosure, it is possible to provide a vehicle lamp that does not require a dedicated reflector (reflecting surface) to reflect light (and its return light) for detecting the detection object (e.g., preceding vehicle, oncoming vehicle, pedestrian, bicycle, and motorcycle) and its installation space, and is capable of being miniaturized.

### BRIEF DESCRIPTION OF DRAWINGS

FIG. 1 is a front view of the vehicle lamp 10 according to the first embodiment;

FIG. 2 is an II-II cross-section view (schematic) of FIG. 1;

FIG. 3A is an IIIA-IIIA cross-section view (schematic) of FIG. 1;

FIG. 3B is an IIIB-IIIB cross-section view (schematic) of FIG. 1;

FIG. 4A illustrates an example of a detection range (first detection range A1) of the LiDAR apparatus 50 itself (original);

FIG. 4B illustrates an example of a second detection range A2 wider than the first detection range A1;

FIG. 5 is a functional block diagram of the LiDAR apparatus 50;

FIG. 6 is a flowchart of an operation example of each of the vehicle lamp 10C1 (LiDAR apparatus 50);

FIG. 7 is a front view of the vehicle lamp 10A according to the second embodiment;

FIG. 8 is a VIII-VIII cross-section view of the vehicle lamp 10A of FIG. 7;

FIG. 9A is an IXA-IXA cross-section view (schematic) of FIG. 7;

FIG. 9B is an IXB-IXB cross-section view (schematic) of FIG. 7;

FIG. 10 is a front view of the vehicle lamp 10B according to the third embodiment;

FIG. 11 is a front view of the vehicle lamp 10C according to the fourth embodiment;

FIG. 12 is a XII-XII cross-section view of FIG. 11;

FIG. 13A is a longitudinal sectional view of the vehicle lamp 10D according to the fifth embodiment;

FIG. 13B is a cross-sectional view of the vehicle lamp 10D according to the fifth embodiment;

FIG. 14 is a front view of the vehicle lamp 10E according to the sixth embodiment;

FIG. 15 is a side view of FIG. 14;

FIG. 16 is a front view of a vehicle V1 mounted with the vehicle lamp 10 (10C, 10E);

FIG. 17 is a front view of a vehicle V2 mounted with the vehicle lamp 10A (10D); and

FIG. 18 is a front view of a vehicle V3 mounted with the vehicle lamp 10B.

### DESCRIPTION OF EMBODIMENTS

### First Embodiment

A vehicle lamp 10 according to a first embodiment of the present disclosure is described below with reference to accompanying drawings. In the drawings, corresponding components are denoted by the same reference numerals, and repetitive description is omitted.

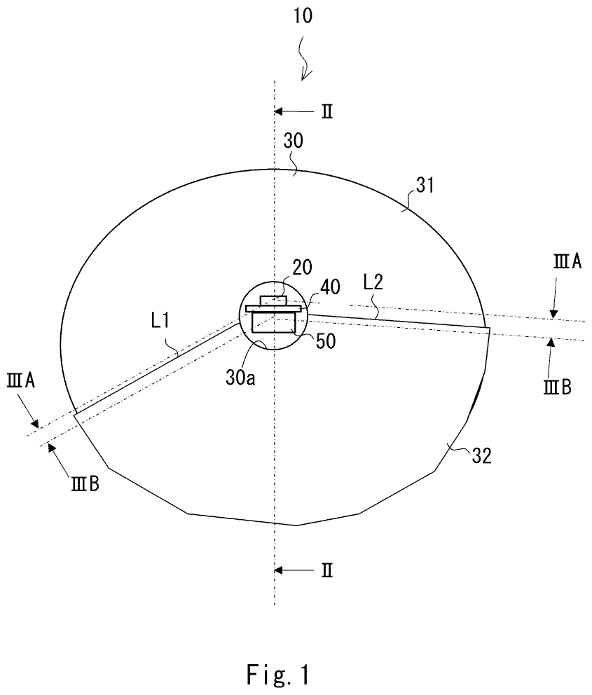

FIG. 1 is a front view of the vehicle lamp 10 according to the first embodiment.

The vehicle lamp 10 according to the first embodiment is a head lamp with built-in LiDAR (Light Detection And Ranging) apparatuses, functioning as a headlamp for low beam, and are mounted on both right and left sides at a front end part of the vehicle V1 such as an automobile. FIG. 16 is a front view of a vehicle V1 mounted with the vehicle lamp 10 (10C, 10E). As shown in FIG. 16, in addition to the low-beam headlamp (vehicle lamp 10), a high-beam headlamp 100 is mounted on the front end of the vehicle V1. That is, the vehicle lamp 10 constitutes a part of a four-lamp system headlamp (reflector type four-lamp system headlamp). The vehicle lamps 10 mounted on both right and left sides are configured symmetrically to each other. Therefore, in the following, the vehicle lamp 10 mounted on the left side (left side in direction toward front side of vehicle) at the front end part of the vehicle V is described as a representative. The explanation for the high-beam headlamp 100 is omitted because an existing high-beam headlamp can be used.

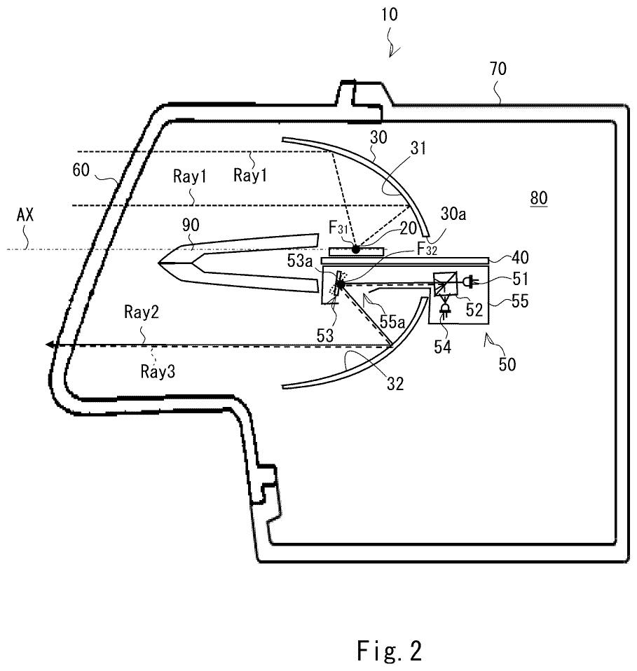

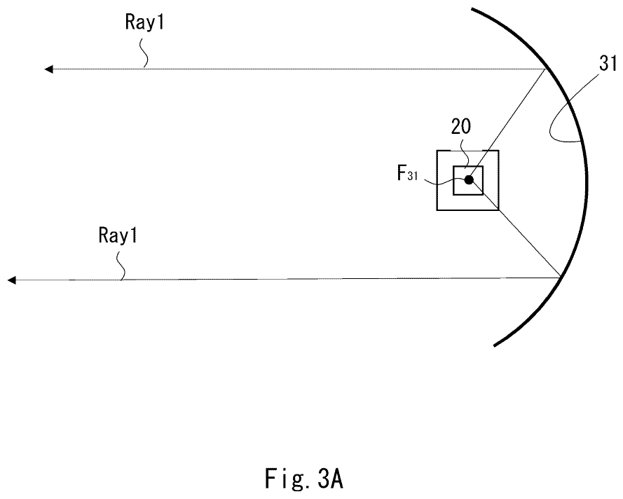

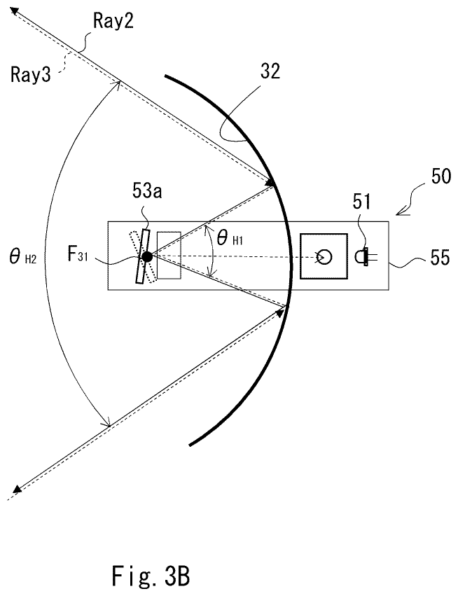

FIG. 2 is an II-II cross-section view (schematic) of FIG. 1. FIG. 3A is an IIIA-IIIA cross-section view (schematic) of FIG. 1. FIG. 3B is an IIIB-IIIB cross-section view (schematic) of FIG. 1. In FIG. 1 and FIG. 3, an outer lens 60 and a housing 70 are omitted.

As shown in FIG. 2, the vehicle lamp 10 includes a first light source 20, a reflector 30, a heat sink 40, and a LiDAR apparatus 50 (LiDAR unit or LiDAR module). the vehicle lamp 10 is arranged in a lamp chamber 80 constituted by an outer lens 60 and a housing 70 and is attached to the housing 70 or the like. In FIG. 2, the reference numeral 90 indicates an extension. The extension 90 is a decorative member that covers and conceals the internal structures (such as the LiDAR apparatus 50) of the vehicle lamp 10 so that they are not visible from the outside.

The first light source 20 is a light source that emits visible light (for example, white light). Specifically, the first light source 20 is a semiconductor light-emitting element such as an LED mounted on a substrate. The first light source 20 has an emitting surface. The emitting surface is, for example, a rectangular emitting surface measuring 1 mm square. The substrate on which the first light source 20 is mounted is held (fixed) to the heat sink 40 with the emitting surface facing upwards. Hereafter, the visible light emitted by the first light source 20 will be referred to as light Ray 1.

As shown in FIG. 1, the outer shape of the reflector 30 is primarily circular in front view, mainly for design reasons. However, the outer shape of the reflector 30 can be various other shapes (for example, polygonal shapes such as rectangular, or elliptical shapes) considering the design relationship with the vehicle on which the vehicle lamp 10 is mounted. The first reflecting surface 31 for the vehicle lamp and the reflecting surface 32 for the LiDAR apparatus are formed on the surface of the reflector 30 on the vehicle front side. The first reflecting surface 31 for the vehicle lamp and the reflecting surface 32 for the LiDAR apparatus are formed, for example, by applying aluminum vapor deposition or similar techniques to a reflector substrate molded from a thermosetting resin such as bulk molding compound (BMC).

The first reflecting surface 31 for the vehicle lamp and the reflecting surface 32 for the LiDAR apparatus are formed inside the outer shape of the reflector 30 in front view (see FIG. 1). Specifically, the first reflecting surface 31 for the vehicle lamp is formed in the upper part inside the outer shape of the reflector 30, while the reflecting surface 32 for the LiDAR apparatus is formed in the lower part inside the outer shape of the reflector 30. In FIG. 1, the reference numerals L1 and L2 indicate boundary lines between the first reflecting surface 31 for the vehicle lamp and the reflecting surface 32 for the LiDAR apparatus. The boundary line L1 corresponds to the diagonal cut-off line of the low-beam light distribution pattern (not shown). On the other hand, the boundary line L2 corresponds to the horizontal cut-off line of the low-beam light distribution pattern.

A through-hole 30a is formed in the central part of the reflector 30 for the insertion of the heat sink 40. The through-hole 30a penetrates the front surface of the reflector 30, on which the first reflecting surface 31 for the vehicle lamp and the reflecting surface 32 for the LiDAR apparatus are formed, and the opposite back surface.

The first reflecting surface 31 for the vehicle lamp is designed to reflect the light Ray1 emitted by the first light source 20 to form a low-beam light distribution pattern. The low-beam light distribution pattern is an example of the first light distribution pattern for the vehicle lamp disclosed herein. For example, the first reflecting surface 31 for the vehicle lamp is a parabolic reflecting surface, and its focal point F₃₁ (see FIG. 2 and FIG. 3A) is located near the first light source 20.

As shown in FIG. 3A, the light Ray1 emitted by the first light source 20 is reflected by the first reflecting surface 31 for the vehicle lamp and projected forward. This forms the low-beam light distribution pattern.

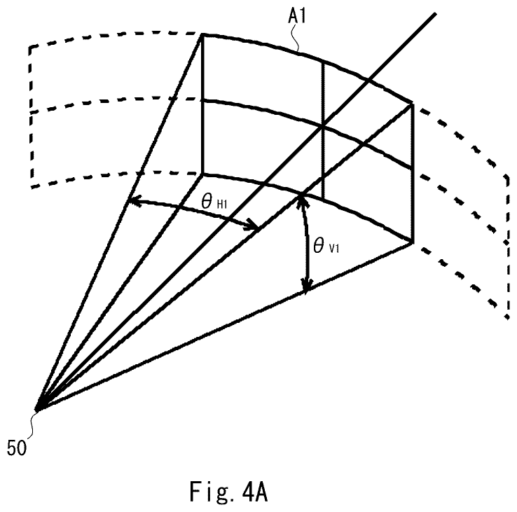

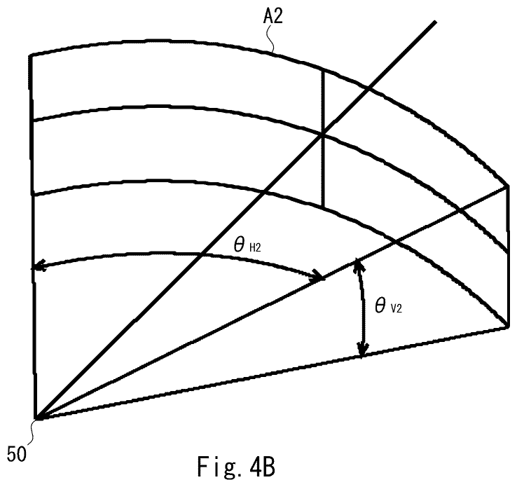

The reflecting surface 32 for the LiDAR apparatus is designed to reflect the laser light Ray2 (light for detecting detection object) transmitted by the LiDAR apparatus 50 (emitted by the second light source 51) and transmit it to a second detection range that is wider than a first detection range. The first detection range and the second detection range are described. FIG. 4A illustrates an example of a detection range (first detection range A1) of the LiDAR apparatus 50 itself (original), and FIG. 4B illustrates an example of a second detection range A2 wider than the first detection range A1.

The first detection range A1 is a detection range originally possessed by the LiDAR apparatus 50, and is a range of a spread angle θ_{H1} in a horizontal direction (viewing angle in horizontal direction) and a spread angle θ_{V1} in a perpendicular direction (viewing angle in horizontal direction) as illustrated in FIG. 4A. For example, the angle θ_{H1} is 20 degrees to 30 degrees, and the angle θ_{V1} is 1 degree to 10 degrees. For example, a resolution in the horizontal direction is 0.5 degrees, a resolution in the perpendicular direction is 0.5 degrees, and a detection (measurement) distance is 100 m to 200 m. On the other hand, the second detection range A2 is a range of a spread angle θ_{H2} in the horizontal direction (viewing angle in horizontal direction) and a spread angle θ_{V2} in the perpendicular direction (viewing angle in horizontal direction) as illustrated in FIG. 4B. For example, the angle θ_{H2} is 90 degrees to 120 degrees, and the angle θ_{V2} is 1 degree to 10 degrees.

The reflecting surface 32 for the LiDAR apparatus is, for example, a revolved parabolic reflecting surface. For example, a vertical cross-sectional shape of the reflecting surface 32 for the LiDAR apparatus is a substantially parabolic shape, and a focal point F₃₂ (see FIG. 2) thereof is positioned near a MEMS mirror 53a. In contrast, a lateral cross-sectional shape of the reflecting surface 32 for the LiDAR apparatus is not a parabolic shape, and is designed such that the light Ray2 reflected by the reflecting surface 32 for the LiDAR apparatus is diffused in the horizontal direction (see FIG. 3B). For example, a radius of curvature of the lateral cross-sectional shape of the reflecting surface 32 for the LiDAR apparatus is designed so as to be greater than a radius of curvature of the vertical cross-sectional shape of the reflecting surface 32 for the LiDAR apparatus. Therefore, the light Ray2 transmitted from the LiDAR apparatus 50 to the range (see FIG. 3B and FIG. 4B) of the spread angle θ_{H1} in the horizontal direction is reflected by the reflecting surface 32 for the LiDAR apparatus, is thereby diffused to the range (see FIG. 3B and FIG. 4B) of the spread angle θ_{H2} in the horizontal direction, and is projected forward. The reflecting surface 32 for the LiDAR apparatus may be a free-form surface, or may include a plurality of reflecting regions formed by dividing (e.g., dividing in lattice shape) the reflecting surface 32 for the LiDAR apparatus. Each of the reflecting regions is designed as a convex surface or a concave surface so as to diffuse the light Ray2 reflected by each of the reflecting regions in the horizontal direction (so-called multi-reflector).

The heat sink 40 includes a base and heat dissipation fins. Note that the heat dissipation fins may be omitted. The heat sink 40 holds the substrate on which the first light source 20 and the LiDAR apparatus 50 are mounted (see FIG. 2). The substrate with the first light source 20 is held (fixed) to the top surface of the heat sink 40 with the emitting surface facing upwards. On the other hand, the LiDAR apparatus 50 (case 55), with the opening portion 55a through which the laser light Ray2 and its return light Ray3 pass, is held (fixed) to the lower surface of the heat sink 40 with the opening portion facing downwards. The heat sink 40 is an example of a holding member in the present disclosure. The heat sink 40 is inserted into the through-hole 30a formed in the reflector 30, and is disposed in a state of being fixed to the housing 70 or the like (see FIG. 2). In this state, the first light source 20 is disposed near the focal point F₃₁ of the first reflecting surface 31 for the vehicle lamp, and the MEMS mirror 53a of the LiDAR apparatus 50 is disposed near the focal point F₃₂ of the reflecting surface 32 for the LiDAR apparatus.

The LiDAR apparatus 50 has a function of transmitting (projecting) the laser light that is the light for detecting a detection object (e.g., preceding vehicle, oncoming vehicle, pedestrian, bicycle, and motorcycle) to the first detection range A1 (detection range originally possessed by LiDAR apparatus 50, see FIG. 4A), a function of receiving return light that is reflected light of the laser light reflected by the detection object, and a function of measuring a distance to a measurement object based on a time from transmission of the laser light until reception of the return light. As illustrated in FIG. 2, the LiDAR apparatus 50 includes the second light source 51, the beam splitter 52, the light deflector 53 (MEMS mirror 53a), the light reception element 54, and the case 55 housing these components. A lens collecting (collimating) the laser light emitted from the second light source 51 may be provided between the second light source 51 and the beam splitter 52. The case 55 is formed with an opening portion 55a through which the laser light emitted from the second light source 51 and the return light thereof pass. As the LiDAR apparatus 50, for example, a LiDAR apparatus disclosed in International Publication No. WO 2020/145095 is usable.

The second light source 51 is a semiconductor light emitting element such as a laser diode (LD) emitting laser light. The laser light emitted from the second light source 51 is an example of the light for detecting the detection object (for scanning first detection range A1) transmitted (projected) to the first detection range A1 (detection range originally possessed by LiDAR apparatus 50, see FIG. 4A). In the following, the laser light emitted from the second light source 51 is referred to as the laser light Ray2. The return light that is reflected light of the laser light Ray2 reflected by the detection object is referred to as return light Ray3. The light emitted from the second light source 51 is, for example, an infrared ray having a wavelength of 905 nm to 1500 nm. The second light source 51 emits (emits in form of pulses) the laser light Ray2 under the control of a light source control unit 50a.

The laser light Ray2 emitted from the second light source 51 passes through the beam splitter 52, and enters the light deflector 53 (MEMS mirror 53a).

The light deflector 53 includes the MEMS mirror 53a that reflects the laser light Ray2 so as to two-dimensionally (in horizontal direction and perpendicular direction) scan the first detection range A1 (see FIG. 4A) with the laser light Ray2. The MEMS mirror 53a is swung around two axes (e.g., horizontal axis and perpendicular axis) orthogonal to each other under the control of a mirror control unit 50b described below, so as to two-dimensionally (in horizontal direction and perpendicular direction) scan the first detection range A1 (see FIG. 4A) with the laser light Ray2 entering and reflected by the MEMS mirror 53a.

As a result, the laser light Ray2 that has been emitted from the second light source 51, passed through the beam splitter 52, and entered the light deflector 53 (MEMS mirror 53a) is transmitted (projected) to the first detection range A1 (see FIG. 4A) (performs two-dimensional scanning of first detection range A1).

The return light Ray3 that is the reflected light of the laser light Ray2 reflected by the detection object returns to the LiDAR apparatus 50 through the optical path same as the optical path of the laser light Ray2, is divided (reflected) toward the light reception element 54 by the beam splitter 52, and enters the light reception element 54. In FIG. 2, FIG. 3B, and other drawings, the return light Ray3 is drawn as a dotted arrow deviated from the laser light Ray2 for facilitating understanding; however, the optical path of the return light Ray3 and the optical path of the laser light Ray2 are actually coincident with each other.

When the return light Ray3 that is the reflected light of the laser light Ray2 reflected by the detection object enters the light reception element 54, the light reception element 54 outputs an electric signal corresponding to intensity of the return light Ray3. The light reception element 54 is, for example, a photodiode or a SPAD (Single Photon Avalanche Diode). The electric signal output from the light reception element 54 is input to a signal processing unit 50c described below.

The LiDAR apparatus 50 (case 55) having the above-described configuration is held (fixed) to the heat sink 40 in a state where the opening portion 55a through which the laser light Ray2 and the return light Ray3 thereof pass is directed downward (see FIG. 2).

In the vehicle lamp 10 having the above-described configuration, the laser light Ray2 emitted from the second light source 51 passes through the beam splitter 52, is reflected by the light deflector 53 (MEMS mirror 53a), and is further reflected by the reflecting surface 32 for the LiDAR apparatus. As a result, the laser light Ray2 is increased in emission angle (in particular, emission angle in horizontal direction), and is transmitted (projected) to the second detection range A2 (see FIG. 4B) wider than the first detection range A1 (detection range originally possessed by LiDAR apparatus 50, see FIG. 4A) (performs two-dimensional scanning of second detection range A2).

Next, the function of the LiDAR apparatus 50 will be described.

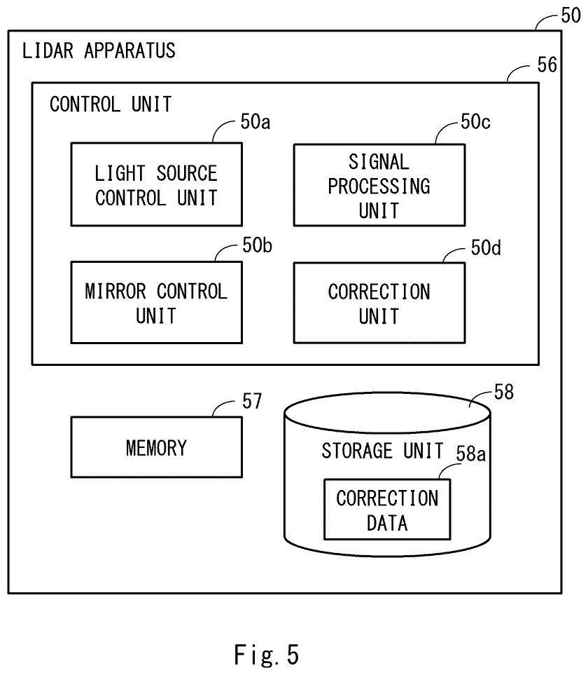

FIG. 5 is a functional block diagram of the LiDAR apparatus 50.

As illustrated in FIG. 5, the LiDAR apparatus 50 includes the control unit 56, the memory 57, and the storage unit 58. The control unit 56 includes, for example, a processor (not illustrated). The processor is, for example, a CPU (Central Processing Unit). One processor or a plurality of processors are provided depending on a case. The processor executes a predetermined program (not illustrated) read from the nonvolatile storage unit 58 such as a flash ROM to the memory 57 (e.g., RAM), thereby functioning as the light source control unit 50a, the mirror control unit 50b, the signal processing unit 50c, and the correction unit 50d. A part or all of these units may be realized by hardware.

The light source control unit 50a controls the second light source 51 to emit light in a form of pulses.

The mirror control unit 50b controls the light deflector 53 (MEMS mirror 53a) so as to two-dimensionally (in horizontal direction and perpendicular direction) scan the first detection range Al (detection range originally possessed by LiDAR apparatus 50, see FIG. 4A), for example, measurement points (e.g., NH measurement points in horizontal direction and Ny measurement points in perpendicular direction) in the first detection range A1, with the laser light Ray2 that enters and is reflected by the MEMS mirror 53a.

The signal processing unit 50c calculates, for each of the measurement points, a distance (distance to each of measurement points) associated with an angle direction of the detection object (e.g., azimuth and elevation angle of each of measurement points) based on a time from transmission of the laser light Ray2 until reception of the return light Ray3 and the like, and outputs the angle direction of the detection object (e.g., azimuth and elevation angle of each of measurement points) and the distance (distance to each of measurement points). The output angle direction of the detection object (e.g., azimuth and elevation angle of each of measurement points) is corrected by the correction unit 50d in a manner described below. Thereafter, the corrected angle direction is stored together with the distance (distance to each of the measurement points) in the memory 57 or the storage unit 58, and is used to detect the detection object (e.g., preceding vehicle, oncoming vehicle, pedestrian, bicycle, and motorcycle).

The correction unit 50d corrects the angle direction of the detection object (e.g., azimuth and elevation angle of each of measurement points) output from the signal processing unit 50c, based on correction data 58a. The correction data 58a is stored in, for example, the storage unit 58.

Technical significance in correcting the angle direction of the detection object (e.g., azimuth and elevation angle of each of measurement points) is as follows. The laser light Ray2 that enters and is reflected by the MEMS mirror 53a is reflected by the reflecting surface 32 for the LiDAR apparatus. Therefore, the laser light Ray2 is actually transmitted not into the first detection range A1 (detection range originally possessed by LiDAR apparatus 50, see FIG. 4A) but to the second detection range A2 (see FIG. 4B) wider than the first detection range A1.

Therefore, for example, the laser light Ray2 to be transmitted to a specific angle direction (e.g., azimuth θ and specific elevation angle φ) is reflected by the reflecting surface 32 for the LiDAR apparatus, and is accordingly actually transmitted to an angle direction (e.g., azimuth θ+Δθ and elevation angle φ+Δφ) different from the specific angle direction (e.g., azimuth θ and specific elevation angle φ).

Therefore, the correction unit 50d corrects the specific angle direction (e.g., azimuth θ and elevation angle φ) output from the signal processing unit 50c to the azimuth θ+Δθ and the elevation angle φ+Δφ based on the correction data. Δθ and Δφ are examples of the correction data. The correction data (Δθ and Δφ) can be previously calculated by tracking a light beam for each angle direction (e.g., azimuth and elevation angle) by using, for example, predetermined simulation software, and stored in the storage unit 58.

Next, an operation example of each of the vehicle lamp 10 (LiDAR apparatus 50) is described.

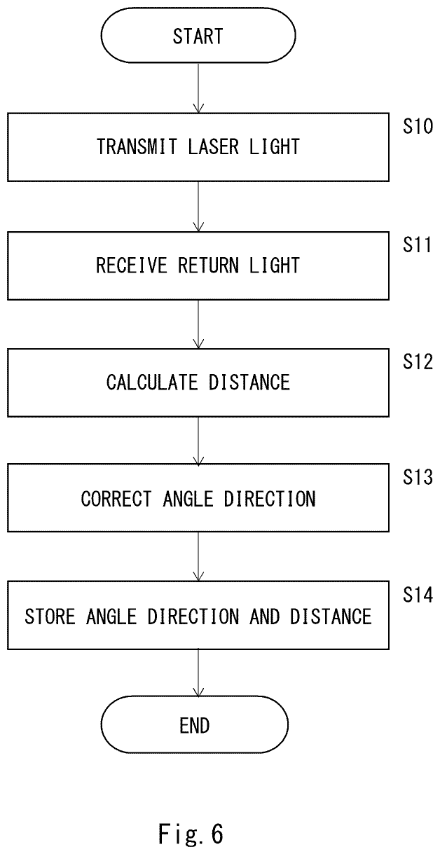

FIG. 6 is a flowchart of an operation example of each of the vehicle lamp 10C1 (LiDAR apparatus 50).

First, the laser light Ray2 is transmitted (step S10). This is realized when the light source control unit 50a controls the second light source 51 to emit light in a form of pulses. The laser light Ray2 emitted from the second light source 51 passes through the beam splitter 52, is reflected by the light deflector 53 (MEMS mirror 53a), and is further reflected by the reflecting surface 32 for the LiDAR apparatus. As a result, the laser light Ray2 is increased in emission angle (in particular, emission angle in horizontal direction), and is transmitted (projected) to the second detection range A2 (see FIG. 4B) wider than the first detection range A1 (detection range originally possessed by LiDAR apparatus 50, see FIG. 4A) (performs two-dimensional scanning of second detection range A2).

Next, the return light Ray3 is received (step S11). The return light Ray3 that is reflected light of the laser light Ray2 transmitted in step S10 and reflected by the detection object returns to the LiDAR apparatus 50 through the optical path same as the optical path of the laser light Ray2, is divided (reflected) toward the light reception element 54 by the beam splitter 52, and enters the light reception element 54. In a case where the return light Ray3 enters the light reception element 54, the light reception element 54 outputs an electric signal corresponding to intensity of the return light Ray3.

Next, the distance to the detection object is calculated (step S12). This is realized by the signal processing unit 50c. The signal processing unit 50c calculates, for each of the measurement points, a distance (distance to each of measurement points) associated with an angle direction of the detection object (e.g., azimuth and elevation angle of each of measurement points) based on a time from transmission of the laser light Ray2 until reception of the return light Ray3 and the like, and outputs the angle direction of the detection object (e.g., azimuth and elevation angle of each of measurement points) and the distance (distance to each of measurement points).

Next, the angle direction of the detection object (e.g., azimuth and elevation angle of each of measurement points) output from the signal processing unit 50c in step S12 is corrected (step S13). This is realized by the correction unit 50d. The correction unit 50d corrects the angle direction of the detection object (e.g., azimuth and elevation angle of each of measurement points) output from the signal processing unit 50c in step S12, based on the correction data 58a.

Next, the angle direction of the detection object (e.g., azimuth and elevation angle of each of measurement points) corrected in step S13 and the distance calculated in step S12 are stored in the memory 57 or the storage unit 58. The stored angle direction of the detection object and the stored distance are used to detect the detection object (e.g., preceding vehicle, oncoming vehicle, pedestrian, bicycle, and motorcycle).

As described above, according to the first embodiment, it is possible to provide a vehicle lamp (low beam headlamp) which is used as a part of a four-lamp system headlamp (reflector type four-lamp system headlamp), that does not require a dedicated reflector (reflecting surface) to reflect light transmitted from a LiDAR apparatus (and its return light) for detecting the detection object and its installation space, and is capable of being miniaturized.

This is due to the use of a reflector (one reflector) formed a reflecting surface for both a vehicle lamp and a reflecting surface for a LiDAR apparatus instead of installing a dedicated reflector (reflecting surface) to reflect light transmitted from a LiDAR apparatus (and its return light) for detecting the detection object, as described in the above-mentioned Patent Literature 1.

Further, according to the first embodiment, since the laser light Ray2 emitted from the second light source 51 (laser light Ray2 scanned by the MEMS mirror 53a) is transmitted to the second detection range A2 (see FIG. 4B) wider than the first detection range A1 (detection range originally possessed by the LiDAR apparatus 50, see FIG. 4A) by being reflected by the reflecting surface 31, it is possible to expand (in particular, in horizontal direction) the detection range (first detection range A1) originally possessed by the LiDAR apparatus 50 to the second detection range A2.

Further, according to the first embodiment, the correction unit 50d that corrects the angle direction of the detection object (e.g., azimuth and elevation angle of each of measurement points) output from the signal processing unit 50c based on the correction data 58a is provided.

Therefore, even when the detection range (first detection range A1) originally possessed by the LiDAR apparatus 50 is expanded to the second detection range A2 as described above, the detection object can be appropriately detected.

### Second Embodiment

Vehicle lamps 10A according to a second embodiment of the present disclosure are described below with reference to accompanying drawings. In the drawings, corresponding components are denoted by the same reference numerals, and repetitive description is omitted.

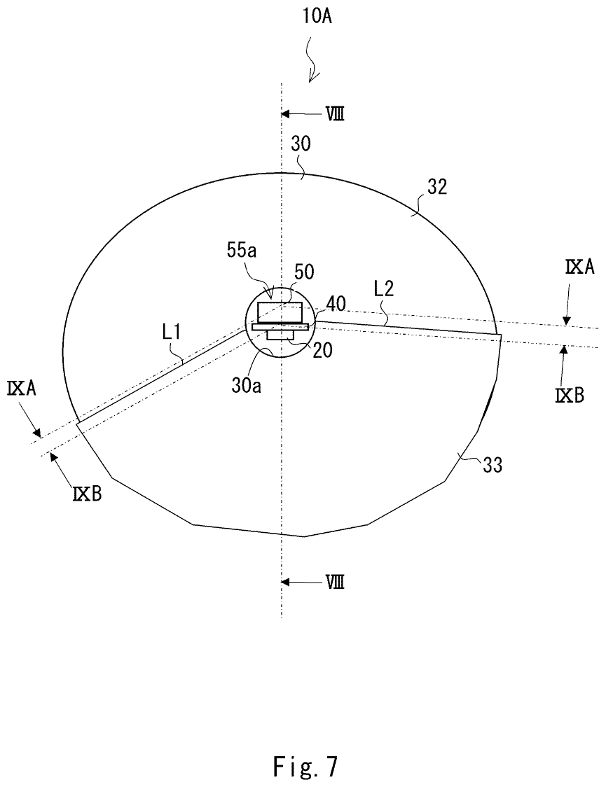

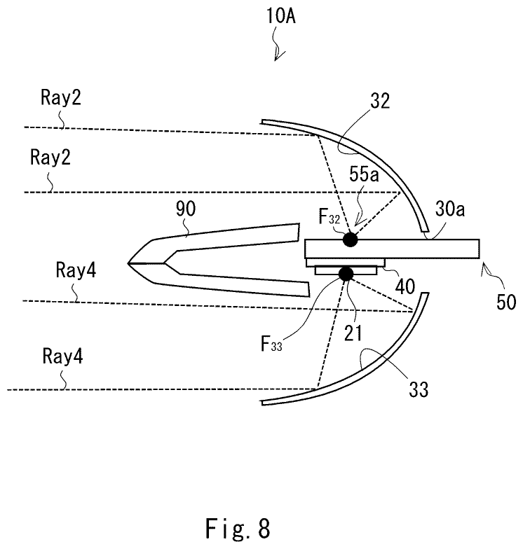

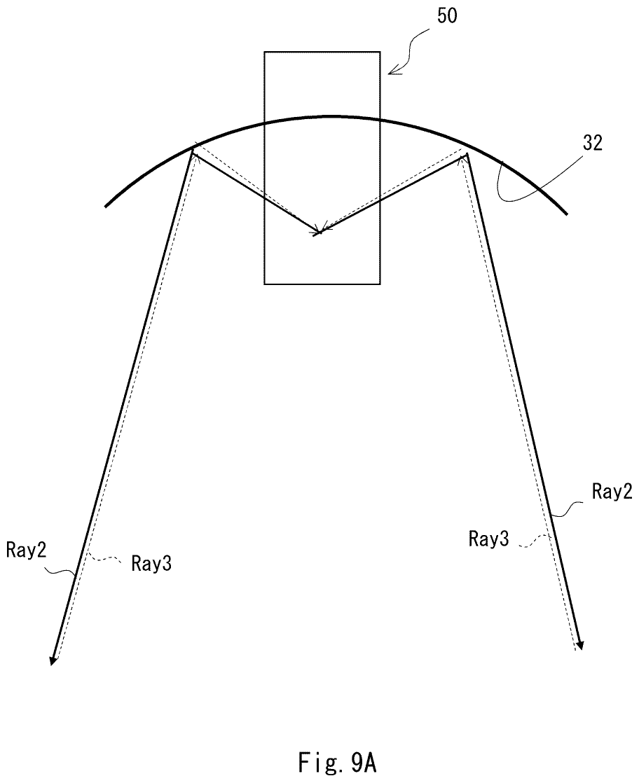

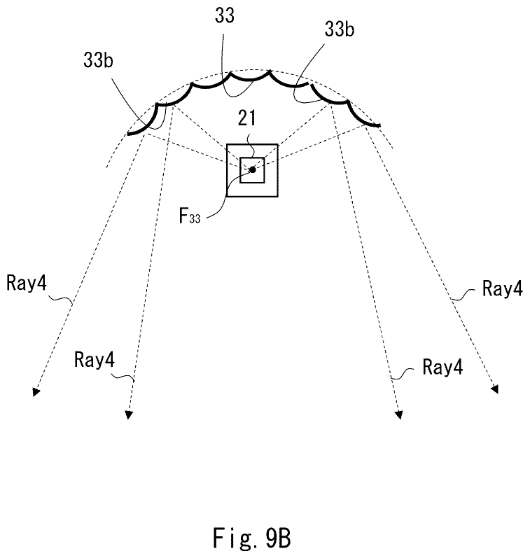

FIG. 7 is a front view of the vehicle lamp 10A according to the second embodiment. FIG. 8 is a VIII-VIII cross-section view of the vehicle lamp 10A of FIG. 7. FIG. 9A is an IXA-IXA cross-section view (schematic) of FIG. 7. FIG. 9B is an IXB-IXB cross-section view (schematic) of FIG. 7. In FIG. 7 to 9, the outer lens 60 and the housing 70 are omitted.

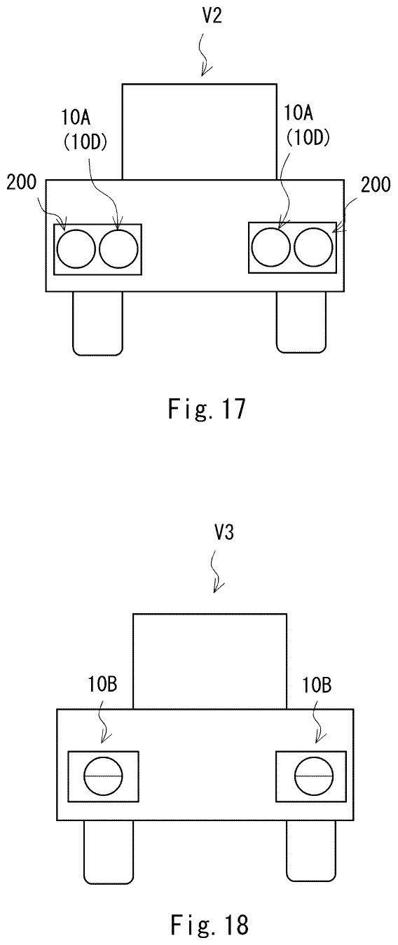

The vehicle lamp 10A according to the second embodiment are head lamps with built-in LiDAR apparatuses, functioning as a headlamp for high beam, and are mounted on both right and left sides at a front end part of the vehicle V1 such as an automobile. FIG. 17 is a front view of a vehicle V2 mounted with the vehicle lamp 10A (10D). As shown in FIG. 17, in addition to a high-beam headlamp (vehicle lamp 10A), a low-beam headlamp 200 is mounted on the front end of the vehicle V2. That is, the vehicle lamp 10A constitutes a part of a four-lamp system headlamp (reflector type four-lamp system headlamp). The vehicle lamp 10A mounted on both right and left sides are configured symmetrically to each other. Therefore, in the following, the vehicle lamp 10A mounted on the left side (left side in direction toward front side of vehicle) at the front end part of the vehicle V2 is described as a representative.

In comparison with the vehicle lamp 10 according to the first embodiment, the vehicle lamp 10A according to the second embodiment has a configuration similar to the configuration of the vehicle lamp 10 according to the first embodiment except for points described below. In the following, differences from the vehicle lamp 10 according to the first embodiment are mainly described, the configuration similar to the configuration of the vehicle lamp 10 according to the first embodiment is denoted by the same reference numeral, and description of the configuration is appropriately omitted.

First, in the vehicle lamp 10 according to the first embodiment, the substrate on which the first light source 20 (light source for low beam) is mounted is held (fixed) to the heat sink 40 with the emitting surface facing upwards. On the other hand, the LiDAR apparatus 50 (case 55), with the opening portion 55a through which the laser light Ray2 and its return light Ray3 pass, is held (fixed) to the heat sink 40 with the opening portion facing downwards (see FIG. 1, FIG. 2). In contrast, in the vehicle lamp 10A according to the second embodiment, the substrate on which the third light source 21 (light source for hi beam) is mounted is held (fixed) to the heat sink 40 with the emitting surface facing downwards. On the other hand, the LiDAR apparatus 50 (case 55), with the opening portion 55a through which the laser light Ray2 and its return light Ray3 pass, is held (fixed) to the heat sink 40 with the opening portion facing upwards (see FIG. 7, FIG. 8). The third light source 21 is the same as the first light source 20. Hereafter, the visible light emitted by the third light source 21 will be referred to as light Ray4.

Second, in the vehicle lamp 10 according to the first embodiment, the first reflecting surface 31 (reflecting surface for low beam) for the vehicle lamp is formed in the upper part inside the outer shape of the reflector 30. On the other hand, the reflecting surface 32 for the LiDAR apparatus is formed in the lower part inside the outer shape of the reflector 30 (see FIG. 1). In contrast, the vehicle lamp 10A according to the second embodiment, the second reflecting surface 33 (reflecting surface for hi beam) for the vehicle lamp is formed in the lower part inside the outer shape of the reflector 30. On the other hand, the reflecting surface 32 for the LiDAR apparatus is formed in the upper part inside the outer shape of the reflector 30 (see FIG. 7).

In addition, the second reflecting surface 33 for the vehicle lamp is designed to reflect the light Ray4 emitted by the third light source 21 to form a hi-beam light distribution pattern. For example, the second reflecting surface 33 for the vehicle lamp is a parabolic reflecting surface, and its focal point F₃₃ (see FIG. 8 and FIG. 9B) is located near the third light source 21. The second reflecting surface 33 for the vehicle lamp may be a free-form surface, or may include a plurality of reflecting regions 33b (see FIG. 9B) formed by dividing the second reflecting surface 33 for the vehicle lamp (e.g., in lattice shape). Each of the reflecting regions 33b is designed as a convex surface or a concave surface so as to diffuse the light Ray4 reflected by each of the reflecting regions 33b in the horizontal direction (so-called multi-reflector).

As described above, according to the second embodiment, the same effects as those of the first embodiment can be achieved. That is, according to the second embodiment, it is possible to provide a vehicle lamp 10A (hi beam headlamp) which is used as a part of a four-lamp system headlamp (reflector type four-lamp system headlamp), that does not require a dedicated reflector (reflecting surface) to reflect light transmitted from a LiDAR apparatus (and its return light) for detecting the detection object and its installation space, and is capable of being miniaturized.

### Third Embodiment

Next, vehicle lamp 10B according to a third embodiment of the present disclosure are described below with reference to accompanying drawings. In the drawings, corresponding components are denoted by the same reference numerals, and repetitive description is omitted.

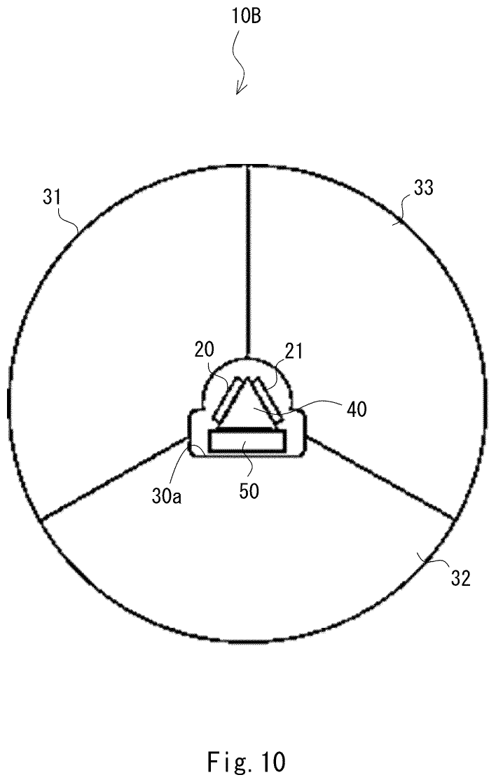

FIG. 10 is a front view of the vehicle lamp 10B according to the third embodiment. In FIG. 10, the outer lens 60 and the housing 70 are omitted.

The vehicle lamp 10B of the third embodiment is a headlamp with a built-in LiDAR apparatus that functions as a headlamp for both a low beam and a high beam, and is mounted on both right and left sides of a front end portion of a vehicle V3 such as an automobile. FIG. 18 is a front view of a vehicle V3 mounted with the vehicle lamp 10B. As shown in FIG. 18, the vehicle lamp 10B constitutes a part of a two-lamp system headlamp (reflector type two-lamp system headlamp). The vehicle lamp 10B mounted on both right and left sides are configured symmetrically to each other. Therefore, in the following, the vehicle lamp 10B mounted on the left side (left side in direction toward front side of vehicle) at the front end part of the vehicle V3 is described as a representative.

In comparison with the vehicle lamp 10 according to the first embodiment, the vehicle lamp 10B according to the third embodiment has a configuration similar to the configuration of the vehicle lamp 10 according to the first embodiment except for points described below. In the following, differences from the vehicle lamp 10 according to the first embodiment are mainly described, the configuration similar to the configuration of the vehicle lamp 10 according to the first embodiment is denoted by the same reference numeral, and description of the configuration is appropriately omitted.

First, in the vehicle lamp 10 according to the first embodiment, the first light source 20 that emits visible light (for example, white light) is provided. In contrast, in the vehicle lamp 10B according to the third embodiment, a third light source 21 that emits visible light (for example, white light) is provided in addition to the first light source 20. The third light source 21 is the same light source as the first light source 20.

Second, in the vehicle lamp 10 according to the first embodiment, the first reflecting surface 31 (reflecting surface for low beam) for the vehicle lamp and the reflecting surface 32 for the LiDAR apparatus are formed on the front surface of the reflector 30 (see FIG. 1). In contrast, in the vehicle lamp 10B according to the third embodiment, in addition to the first reflecting surface 31 for a vehicle lamp and the reflecting surface 32 for a LiDAR apparatus, a second reflecting surface 33 (reflecting surface for hi beam) for a vehicle lamp is formed on the front surface of the vehicle of the reflector 30. The second reflecting surface 33 for the vehicle lamp has already been described in the second embodiment, so its explanation will be omitted here. In FIG. 10, the first reflecting surface 31 for the vehicle lamp, the second reflecting surface 33 for the vehicle lamp, and the reflecting surface 32 for the LiDAR apparatus are arranged in a clockwise order, but this is not limited to this order. The first reflecting surface 31 for the vehicle lamp, the second reflecting surface 33 for the vehicle lamp, and the reflecting surface 32 for the LiDAR apparatus can be arranged in any order. Furthermore, while the central angle for each of the first reflecting surface 31 for the vehicle lamp, the second reflecting surface 33 for the vehicle lamp, and the reflecting surface 32 for the LiDAR apparatus is 120°, it is not limited to this and can be any appropriate central angle.

Third, in the vehicle lamp 10 according to the first embodiment, the heat sink 40 has an upper surface where the substrate on which the first light source 20 (light source for low beam) is mounted is fixed, and a lower surface where the LiDAR apparatus 50 is fixed (see FIG. 2). In contrast, in the vehicle lamp 10B according to the third embodiment, the heat sink 40 has a triangular prism shape whose side surfaces are composed of a surface on which a substrate on which the first light source 20 is mounted is fixed, a surface on which a substrate on which the third light source 21 (light source for high beam) is mounted is fixed, and a surface on which the LiDAR apparatus 50 is fixed (see FIG. 10).

Fourth, in the vehicle lamp 10 according to the first embodiment, the heat sink 40 is inserted into a through-hole 30a formed in the reflector 30, and is disposed in a state of being fixed to the housing 70 or the like (see FIG. 2). In this state, the first light source 20 is disposed near the focal point F₃₁ of the first reflecting surface 31 for the vehicle lamp, and the MEMS mirror 53a of the LiDAR apparatus 50 is disposed near the focal point F₃₂ of the reflecting surface 32 for the LiDAR apparatus. In contrast, in the vehicle lamp 10B according to the third embodiment, the heat sink 40 is inserted into a through-hole 30a formed in the reflector 30, and is disposed in a state of being fixed to the housing 70 or the like (see FIG. 2). In this state, the first light source 20 is disposed near the focal point F₃₁ of the first reflecting surface 31 for the vehicle lamp, the third light source 21 is disposed near the focal point F₃₃ of the second reflecting surface 33 for the vehicle lamp, and the MEMS mirror 53a of the LiDAR apparatus 50 is disposed near the focal point F₃₂ of the reflecting surface 32 for the LiDAR apparatus.

As described above, according to the third embodiment, the same effects as those of the first embodiment can be achieved. That is, according to the third embodiment, it is possible to provide a vehicle lamp 10B (headlamp for both low beam and high beam) which is used as a part of a two-lamp system headlamp (reflector type two-lamp system headlamp), that does not require a dedicated reflector (reflecting surface) to reflect light transmitted from a LiDAR apparatus (and its return light) for detecting the detection object and its installation space, and is capable of being miniaturized.

### Fourth Embodiment

Next, vehicle lamp 10C according to a fourth embodiment of the present disclosure are described below with reference to accompanying drawings. In the drawings, corresponding components are denoted by the same reference numerals, and repetitive description is omitted.

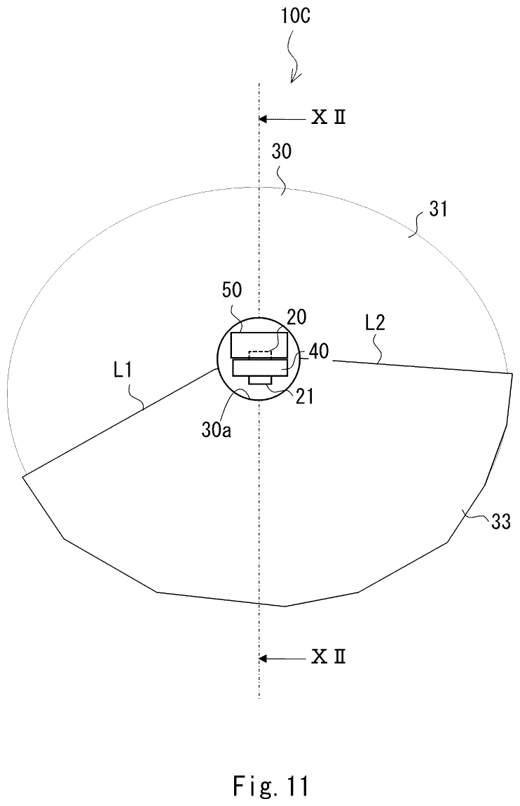

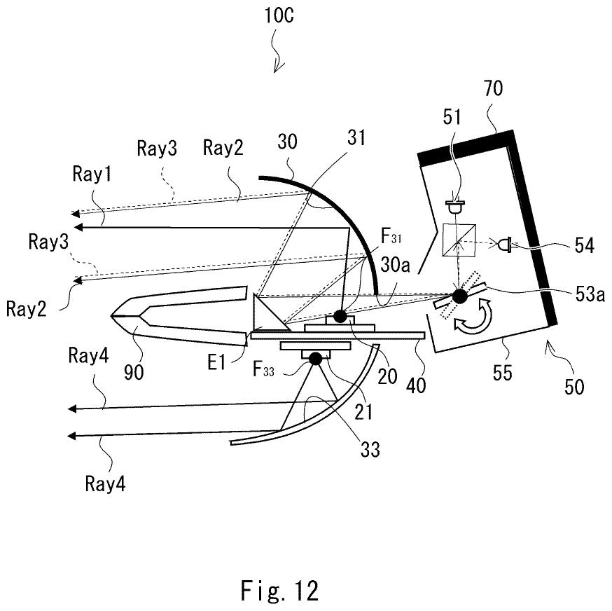

FIG. 11 is a front view of the vehicle lamp 10C according to the fourth embodiment. In FIG. 11, the outer lens 60 and the housing 70 are omitted. FIG. 12 is a XII-XII cross-section view of FIG. 11.

The vehicle lamp 10C of the fourth embodiment is a headlamp with a built-in LiDAR apparatus that functions as a headlamp for both a low beam and a high beam, and is mounted on both right and left sides of a front end portion of a vehicle V1 such as an automobile. As shown in FIG. 16, in addition to a headlamp (the vehicle lamp 10C) for both a low beam and a high beam, a high-beam headlamp 100 is mounted on the front end of the vehicle V1. That is, the vehicle lamp 10C constitutes a part of a four-lamp system headlamp (reflector type four-lamp system headlamp). The vehicle lamp 10C mounted on both right and left sides are configured symmetrically to each other. Therefore, in the following, the vehicle lamp 10C mounted on the left side (left side in direction toward front side of vehicle) at the front end part of the vehicle V is described as a representative. In comparison with the vehicle lamp 10 according to the first embodiment, the vehicle lamp 10C according to the fourth embodiment has a configuration similar to the configuration of the vehicle lamp 10 according to the first embodiment except for points described below. In the following, differences from the vehicle lamp 10 according to the first embodiment are mainly described, the configuration similar to the configuration of the vehicle lamp 10 according to the first embodiment is denoted by the same reference numeral, and description of the configuration is appropriately omitted.

First, in the vehicle lamp 10 according to the first embodiment, the LiDAR apparatus 50 (case 55) is fixed to the lower surface of the heat sink 40 (see FIG. 1, FIG. 2). In contrast, in the vehicle lamp 10C according to the fourth embodiment, a substrate on which the third light source 21 (light source for high beam) is mounted instead of the LiDAR apparatus 50 (case 55) is fixed to the lower surface of the heat sink 40 with the light emitting surface facing down (See FIG. 11 and FIG. 12).

Second, in the vehicle lamp 10 according to the first embodiment, the reflecting surface 32 for the LiDAR apparatus is formed in the lower part inside the outer shape of the reflector 30 (see FIG. 1). In contrast, in the vehicle lamp 10C according to the fourth embodiment, the second reflecting surface 33 (reflecting surface for hi beam) instead of the reflecting surface 32 for the LiDAR apparatus is formed on the lower surface of the heat sink 40.

Third, in the vehicle lamp 10 according to the first embodiment, the heat sink 40 is inserted into a through-hole 30a formed in the reflector 30, and is disposed in a state of being fixed to the housing 70 or the like (see FIG. 2). In this state, the first light source 20 is disposed near the focal point F₃₁ of the first reflecting surface 31 for the vehicle lamp, and the MEMS mirror 53a of the LiDAR apparatus 50 is disposed near the focal point F₃₂ of the reflecting surface 32 for the LiDAR apparatus. In contrast, in the vehicle lamp 10C according to the fourth embodiment, the heat sink 40 is inserted into a through-hole 30a formed in the reflector 30, and is disposed in a state of being fixed to the housing 70 or the like (see FIG. 2). In this state, the first light source 20 is disposed near the focal point F₃₁ of the first reflecting surface 31 for the vehicle lamp, and the third light source 21 is disposed near the focal point F₃₃ of the second reflecting surface 33 for the vehicle lamp.

Fourth, in the vehicle lamp 10C of the fourth embodiment, unlike the first embodiment, the LiDAR apparatus 50 is disposed behind the reflector 30 in a state of being fixed to the housing 70 or the like (see FIG. 12). The LiDAR apparatus 50 is disposed while considering the distance from and the orientation towards the second reflecting surface 33 for the vehicle lamp, to achieve the following two points: first, the laser light Ray2 is increased in emission angle (in particular, emission angle in horizontal direction). The laser light Ray2 emitted by the second light source 51 passes through the through-hole 30a, is reflected by the reflecting member E1, and further reflected by the second reflecting surface 33 for the vehicle lamp. second, the laser light Ray2 is transmitted (projected) to the second detection range A2 (see FIG. 4B) wider than the first detection range Al (detection range originally possessed by LiDAR apparatus 50, see FIG. 4A) (performs two-dimensional scanning of second detection range A2).

Fifth, in the vehicle lamp 10C of the fourth embodiment, unlike the first embodiment, between the LiDAR apparatus 50 and a second reflecting surface 33 for a vehicle lam, a reflecting member E1 for reflecting a laser light Ray2 emitted from the second light source 51 and passing through the through-hole 30a toward a first reflecting surface 31 for a vehicle lamp is provided. As a result, the first reflecting surface 31 for the vehicle lamp also functions as the reflecting surface 32 for the LiDAR apparatus. The reflecting member E1 is, for example, a mirror or prism.

As described above, according to the fourth embodiment, the same effects as those of the first embodiment can be achieved. That is, according to the fourth embodiment, it is possible to provide a vehicle lamp 10C (headlamp for both low beam and high beam) which is used as a part of a four-lamp system headlamp (reflector type four-lamp system headlamp), that does not require a dedicated reflector (reflecting surface) to reflect light transmitted from a LiDAR apparatus (and its return light) for detecting the detection object and its installation space, and is capable of being miniaturized.

### Fifth Embodiment

Next, vehicle lamp 10D according to a fifth embodiment of the present disclosure are described below with reference to accompanying drawings. In the drawings, corresponding components are denoted by the same reference numerals, and repetitive description is omitted.

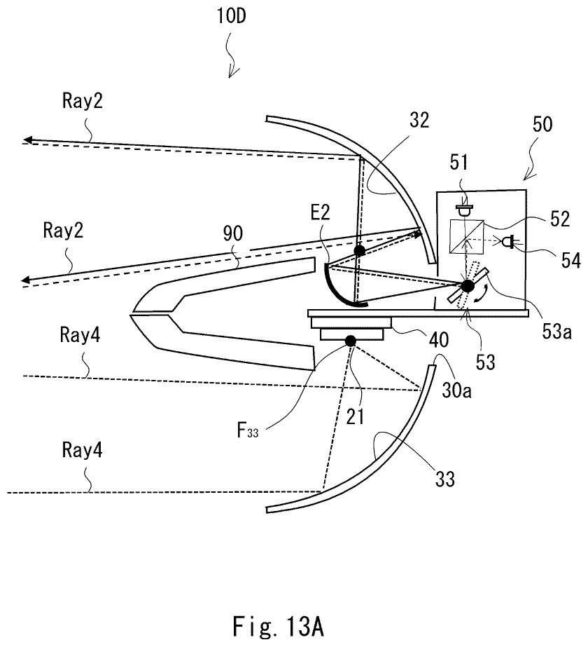

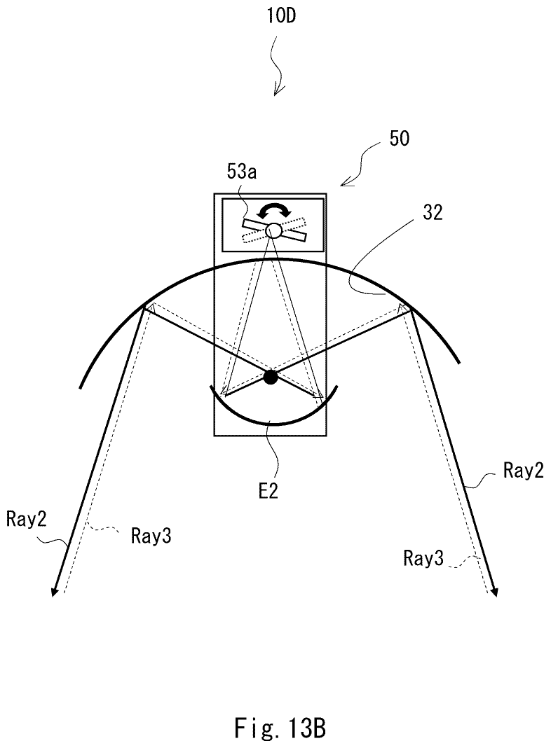

FIG. 13A is a longitudinal sectional view of the vehicle lamp 10D according to the fifth embodiment and FIG. 13B is a cross-sectional view of the vehicle lamp 10D according to the fifth embodiment. In FIG. 13, the outer lens 60 and the housing 70 are omitted.

The vehicle lamp 10D of the fifth embodiment, like the vehicle lamp 10A of the second embodiment, functions as a high beam headlamp and is a headlamp with a built-in LiDAR device, installed on both the left and right sides of the front end of a vehicle V2, such as an automobile. As shown in FIG. 17, in addition to a high-beam headlamp (vehicle lamp 10D), a low-beam headlamp 200 is mounted on the front end of the vehicle V2. That is, the vehicle lamp 10D constitutes a part of a four-lamp system headlamp (reflector type four-lamp system headlamp). The vehicle lamp 10D mounted on both right and left sides are configured symmetrically to each other. Therefore, in the following, the vehicle lamp 10D mounted on the left side (left side in direction toward front side of vehicle) at the front end part of the vehicle V2 is described as a representative.

In comparison with the vehicle lamp 10A according to the second embodiment, the vehicle lamp 10D according to the fifth embodiment has a configuration similar to the configuration of the vehicle lamp 10A according to the second embodiment except for points described below. In the following, differences from the vehicle lamp 10A according to the second embodiment are mainly described, the configuration similar to the configuration of the vehicle lamp 10A according to the second embodiment is denoted by the same reference numeral, and description of the configuration is appropriately omitted.

First, in the vehicle lamp 10D according to the fifth embodiment, unlike the second embodiment, as shown in FIG. 13A, the LiDAR apparatus 50 is disposed behind the reflector 30 in a state of being fixed to the housing 70 or the like.

Second, in the vehicle lamp 10D according to the fifth embodiment, unlike the second embodiment, a reflecting member E2 is provided between the LiDAR apparatus 50 and the reflecting surface 32 for the LiDAR apparatus (reflecting surface for high beam) (see FIG. 13A). The reflecting member E2 reflects the laser beam Ray2 emitted from the second light source 51 and passing through the through-hole 30a towards the reflecting surface 32 for the LiDAR apparatus. The reflecting member E2 is an elliptical reflecting surface (hereinafter referred to as the elliptical reflecting surface E2). As a result, as shown in FIG. 13B, the laser light Ray2 reflected by the elliptical reflecting surface E2 crosses and is directed towards the reflecting surface 32 for the LiDAR apparatus, where it is reflected and diffused horizontally.

As described above, according to the fifth embodiment, the same effects as those of the first embodiment can be achieved. That is, according to the fifth embodiment, it is possible to provide a vehicle lamp 10D (hi beam headlamp) which is used as a part of a four-lamp system headlamp (reflector type four-lamp system headlamp), that does not require a dedicated reflector (reflecting surface) to reflect light transmitted from a LiDAR apparatus (and its return light) for detecting the detection object and its installation space, and is capable of being miniaturized.

### Sixth Embodiment

Next, vehicle lamp 10E according to a sixth embodiment of the present disclosure are described below with reference to accompanying drawings. In the drawings, corresponding components are denoted by the same reference numerals, and repetitive description is omitted.

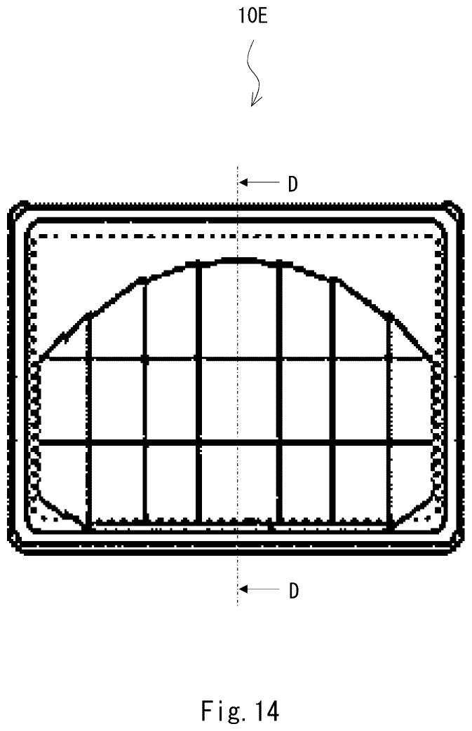

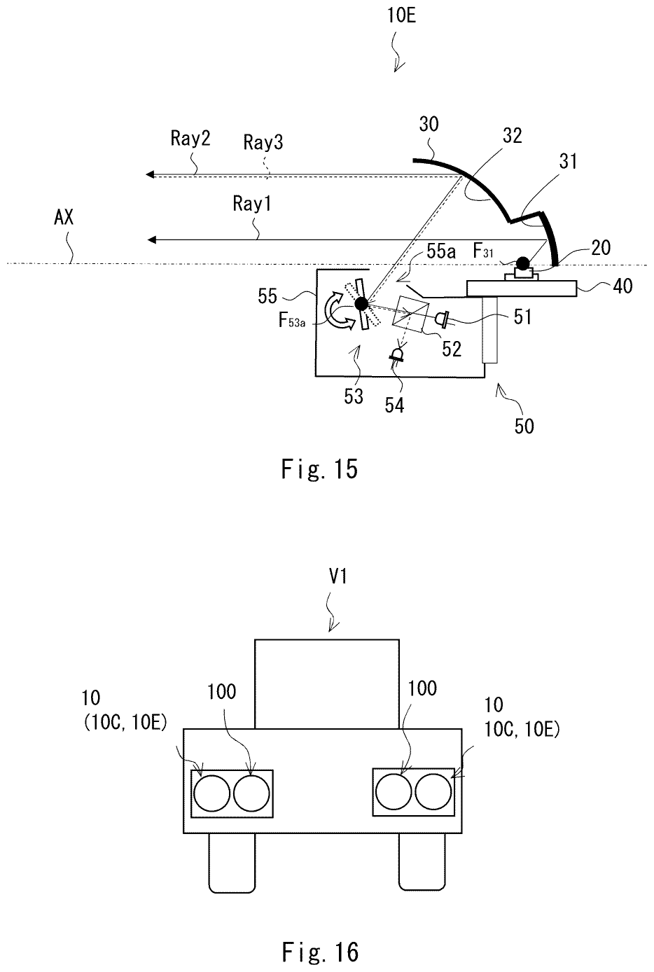

FIG. 14 is a front view of the vehicle lamp 10E according to the sixth embodiment, and FIG. 15 is a side view of FIG. 14. In FIG. 14 to FIG. 15, the outer lens 60 and the housing 70 are omitted. The vehicle lamp 10E according to the sixth embodiment are head lamps with built-in LiDAR apparatuses, functioning as a headlamp for low beam, and are mounted on both right and left sides at a front end part of the vehicle V1 such as an automobile. As shown in FIG. 16, in addition to a low-beam headlamp (vehicle lamp 10E), a high-beam headlamp 100 is mounted on the front end of the vehicle V1. That is, the vehicle lamp 10E constitutes a part of a four-lamp system headlamp (reflector type four-lamp system headlamp). The vehicle lamp 10E mounted on both right and left sides are configured symmetrically to each other. Therefore, in the following, the vehicle lamp 10E mounted on the left side (left side in direction toward front side of vehicle) at the front end part of the vehicle V1 is described as a representative.

In comparison with the vehicle lamp 10 according to the first embodiment, the vehicle lamp 10E according to the sixth embodiment has a configuration similar to the configuration of the vehicle lamp 10 according to the first embodiment except for points described below. In the following, differences from the vehicle lamp 10 according to the first embodiment are mainly described, the configuration similar to the configuration of the vehicle lamp 10 according to the first embodiment is denoted by the same reference numeral, and description of the configuration is appropriately omitted.

First, in the vehicle lamp 10 according to the first embodiment, the outer shape of the reflector 30 is a circular shape in front view (see FIG. 1). In contrast, in the vehicle lamp 10E according to the sixth embodiment, as shown in FIG. 14, the outer shape of the reflector 30 is a semicircular shape in the front view mainly for design reasons.

Second, in the vehicle lamp 10 according to the first embodiment, the first reflecting surface 31 (reflecting surface for low beam) for a vehicle lamp is disposed above the reference axis AX extending in the vehicle longitudinal direction through the focal point F₃₁ of the first reflecting surface 31 for the vehicle lamp (see FIG. 2). And the reflecting surface 32 for the LiDAR apparatus is disposed below the reference axis AX (see FIG. 2). In contrast, in the vehicle lamp 10E according to the sixth embodiment, as shown in FIG. 15, the first reflecting surface 31 (reflecting surface for low beam) for a vehicle lamp and the reflecting surface 32 for the LiDAR apparatus both disposed above the reference axis AX.

Third, in the vehicle lamp 10 according to the first embodiment, the substrate on which the first light source 20 (light source for low beam) is mounted is held (fixed) to the heat sink 40 with the emitting surface facing upwards. On the other hand, the LiDAR apparatus 50 (case 55), with the opening portion 55a through which the laser light Ray2 and its return light Ray3 pass, is held (fixed) to the heat sink 40 with the opening portion facing downwards (see FIG. 1, FIG. 2). In contrast, in the vehicle lamp 10E according to the sixth embodiment, as shown in FIG. 15, the substrate on which the first light source 20 (light source for low beam) is mounted is held (fixed) to the heat sink 40 with the emitting surface facing upwards. And the LiDAR apparatus 50 (case 55), with the opening portion 55a through which the laser light Ray2 and its return light Ray3 pass, is held (fixed) to the heat sink 40 with the opening portion facing upwards.

As described above, according to the sixth embodiment, the same effects as those of the first embodiment can be achieved. That is, according to the sixth embodiment, it is possible to provide a vehicle lamp 10E (low beam headlamp) which is used as a part of a four-lamp system headlamp (reflector type four-lamp system headlamp), that does not require a dedicated reflector (reflecting surface) to reflect light transmitted from a LiDAR apparatus (and its return light) for detecting the detection object and its installation space, and is capable of being miniaturized.

Modified examples are described.

In the above-described embodiments, the example in which the vehicle lamp according to the present disclosure is applied to the vehicle head lamps is described; however, the application is not limited thereto.

For example, the vehicle lamp according to the present disclosure may be applied to a vehicle signal lamp or other vehicle lamps.

In the above-described embodiments, the example in which the scanning LiDAR apparatus 50 is used as the LiDAR apparatus is described; however, the LiDAR apparatus is not limited thereto. As the LiDAR apparatus, a flash LiDAR apparatus (not illustrated) or other LiDAR apparatuses may be used.

The numerical values described in the above-described embodiments are all illustrative, and appropriate numerical values different from the numerical values described in the above-described embodiments can be used as a matter of course.

The above-described embodiments are merely illustrative in all aspects. The present disclosure is not limitedly interpreted by the description of the above-described embodiments. The present disclosure can be implemented in other various forms without departing from the spirit or main features of the present disclosure.

This application is based on and claims the benefit of priority from Japanese Patent Application No. 2022-039422 filed on Mar. 14, 2022, the contents of which are hereby incorporated by reference.

### REFERENCE SIGNS LIST

10, 10A, 10B, 10C, 10D. 10E . . . VEHICLE LAMP, 20 . . . FIRST LIGHT SOURCE, 21 . . . THIRD LIGHT SOURCE, 30 . . . REFLECTOR, 30A . . . THROUGH-HOLE, 31 . . . FIRST REFLECTING SURFACE, 32 . . . REFLECTING SURFACE, 33 . . . SECOND REFLECTING SURFACE, 33B . . . REFLECTING REGIONS, 40 . . . HEAT SINK., 50 . . . LIDAR APPARATUS, 50A . . . LIGHT SOURCE CONTROL UNIT, 50B . . . MIRROR CONTROL UNIT, 50C . . . SIGNAL PROCESSING UNIT, 50D . . . CORRECTION UNIT, 51 . . . SECOND LIGHT SOURCE, 52 . . . BEAM SPLITTER, 53 . . . LIGHT DEFLECTOR, 53A . . . MEMS MIRROR, 54 . . . LIGHT RECEPTION ELEMENT, 55 . . . CASE, 55A . . . OPENING PORTION, 56 . . . CONTROL UNIT, 57 . . . MEMORY, 58 . . . STORAGE UNIT, 58A . . . CORRECTION DATA, 60 . . . OUTER LENS, 70 . . . HOUSING, 80 . . . LAMP CHAMBER, 90 . . . EXTENSION, A1 . . . FIRST DETECTION RANGE, A2 . . . SECOND DETECTION RANGE, E1, E2 . . . REFLECTING MEMBER

1. A vehicle lamp, comprising:
a first light source that emits visible light;
a first reflecting surface for the vehicle lamp that is designed to reflect the visible light emitted by the first light source to form a first light distribution pattern;
a second light source that emits light for detecting a detection object transmitted to a first detection range;
a light reception element that outputs an electric signal corresponding to intensity of a return light, when the return light that is the reflected light of the light reflected by the detection object is entered;
a LiDAR apparatus that has the second light source and light reception element;
a reflecting surface for the LiDAR apparatus that is designed to reflect the light for detecting the detection object and transmit it to a second detection range that is wider than the first detection range; and
a reflector formed with the first reflecting surface for the vehicle lamp and the reflecting surface for the LiDAR apparatus.

2. The vehicle lamp according to claim 1,
the LiDAR apparatus includes a MEMS mirror for reflecting the light for detecting a detection object so that the light for detecting a detection object scans the first detection range.

3. The vehicle lamp according to claim 1, wherein
the first reflecting surface for the vehicle lamp and the reflecting surface for the LiDAR apparatus are formed inside the outer shape of the reflector in front view.

4. The vehicle lamp according to claim 1, wherein
the outer shape of the reflector is a circular shape in front view.

5. The vehicle lamp according to claim 1, wherein
the reflecting surface for the LiDAR apparatus is designed such that the light for detecting a detection object reflected by the reflecting surface for the LiDAR apparatus is diffused in the horizontal direction.

6. The vehicle lamp according to claim 2, wherein
a vertical cross-sectional shape of the reflecting surface for the LiDAR apparatus is a substantially parabolic shape, and a focal point thereof is positioned near the MEMS mirror, and
a radius of curvature of the lateral cross-sectional shape of the reflecting surface for the LiDAR apparatus is greater than a radius of curvature of the vertical cross-sectional shape of the reflecting surface for the LiDAR apparatus.

7. The vehicle lamp according to claim 1, wherein
the reflecting surface for the LiDAR apparatus includes a plurality of reflecting regions formed by dividing the reflecting surface for the LiDAR apparatus, and
each of the reflecting regions is designed as a convex surface or a concave surface so as to diffuse the light for detecting the detection object emitted by the second light source and reflected by each of the reflecting regions in the horizontal direction.

8. The vehicle lamp according to claim 1, wherein
the reflector has a through-hole,
the vehicle lamp, further comprising:
a holding member for holding the first light source and the LiDAR apparatus, wherein
the holding member is disposed in a state of being inserted into the through-hole.

9. The vehicle lamp according to claim 8, further comprising:
a third light source that emits visible light;
a second reflecting surface for the vehicle lamp that is designed to reflect the visible light emitted by the third light source to form a second light distribution pattern; wherein
the holding member has a triangular prism shape, and
the first light source, the LiDAR apparatus, and the third light source are each fixed to surfaces that constitute the sides of the triangular prism shape.

10. The vehicle lamp according to claim 8, wherein
the holding member is a heat sink.

11. The vehicle lamp according to claim 1, wherein
the LiDAR apparatus is disposed behind the reflector,
the vehicle lamp, further comprising:
a reflecting member for reflecting light for detecting a detection object emitted from the second light source and passing through the through-hole toward the reflecting surface for the LiDAR apparatus.

12. The vehicle lamp according to claim 11, wherein
the reflecting member is a mirror or a prism.

13. The vehicle lamp according to claim 11, wherein
the reflecting member is a condensing reflecting surface,
the light reflected by the condensing reflecting surface crosses and is directed towards the reflecting surface for the LiDAR apparatus.

14. The vehicle lamp according to claim 1, further comprising:
a signal processing unit that calculates the distance to the detection object based on the electrical signal output by the light reception element and outputs the angle of the detection object and the distance to the detection object;
a storage unit in that a correction data is stored;
a correction unit that corrects the angle of the detection object outputted from the signal processing unit, based on the correction data.
